(19) United States
(12) Patent Application Publication
(10) Pub. No.: US 2026/0008199 A1
(43) Pub. Date: Jan. 8, 2026

(54) METHODS AND APPARATUS FOR MANUFACTURING POTATO CRISPS

(71) Applicant: Mindful Snacker Company Limited, London (GB)

(72) Inventor: Robert Douglas WHITE, London (GB)

(21) Appl. No.: 19/325,072

(22) Filed: Sep. 10, 2025

Related U.S. Application Data
(63) Continuation of application No. PCT/GB2024/050637, filed on Mar. 8, 2024.

(30) Foreign Application Priority Data
Mar. 10, 2023 (GB) 2303526.4

(51) Int. Cl. B26D 7/06; A23L 19/18; B26D 7/32

(52) U.S. Cl. CPC B26D 7/0641; A23L 19/18; B26D 7/32; B26D 2210/02

(57) ABSTRACT

Provided is an apparatus for producing potato slices from potatoes. The apparatus comprises a spaced array of receptacles, each receptacle comprising a respective inlet for receiving a potato, and a respective outlet through which the potato can protrude. The apparatus also comprises a retainer for limiting an extent to which the potatoes protrude from the outlets of the receptacles, and a cutting tool comprising a cutting edge for cutting the potatoes. The receptacles are each movable in a reciprocating motion relative to the cutting tool to cause a part of the potato protruding from the respective outlet to pass across the cutting edge so that the potato is sliced by the cutting edge to produce the potato slices. The apparatus also comprises a conveyor arranged to capture the potato slices.

### CROSS-REFERENCE TO RELATED APPLICATIONS

This application is a continuation under 35 U.S.C. § 120 of International Application No. PCT/GB2024/050637, filed Mar. 8, 2024, which claims priority to United Kingdom Application No. GB 2303526.4, filed Mar. 10, 2023, under 35 U.S.C. § 119(a). Each of the above-referenced patent applications is incorporated by reference in its entirety.

### Technical Field

The present invention relates to methods and apparatus for producing potato slices from a potato, to methods and apparatus for washing and performing lipophilic preconditioning of potato slices in the manufacture of potato crisps, to methods of manufacturing potato crisps, and to manufacturing lines for manufacturing potato crisps.

### BACKGROUND

Potato crisps (also known colloquially as “potato chips”) have for many years been produced by frying slices of potato in oil. This provides a potato crisp having an oil content of about 35 wt. %, based on the total weight of the potato crisp. Health-conscious consumers are seeking potato crisps which have a lower oil content while maintaining desirous organoleptic properties, such as texture, colour and flavour. This presents a challenge for snack food manufacturers.

Recent developments include modifying the frying temperatures of fried potato crisps or baking, instead of frying, the potato crisps. In some cases, however, these potato crisps have been found to lack the taste, texture and/or colour consumers associate with fried potato crisps. There is therefore scope to improve manufacturing processes of lower-oil-content potato crisps to provide a healthier alternative snack food to fried potato crisps without compromising on the sensational attributes expected by consumers from such potato crisps.

### SUMMARY

According to a first aspect of the present invention, provided is an apparatus for producing potato slices from potatoes, the apparatus comprising: a spaced array of receptacles, each receptacle comprising a respective inlet for receiving a potato, and a respective outlet through which the potato can protrude; a retainer for limiting an extent to which the potatoes protrude from the outlets of the receptacles; and a cutting tool comprising a cutting edge for cutting the potatoes; wherein the receptacles are each movable in a reciprocating motion relative to the cutting tool to cause a part of the potato protruding from the respective outlet to pass across the cutting edge so that the potato is sliced by the cutting edge to produce the potato slices; and wherein the apparatus comprises a conveyor arranged to capture the potato slices.

In this way, the potatoes may be caused to move in a reciprocating motion relative to the cutting tool and cutting edge, in use, to produce a series of potato slices from each potato. The conveyor may be configured to move the potato slices away from the cutting tool. In this way, the apparatus may provide a series of potato slices spaced apart on the conveyor.

Optionally, the cutting tool comprises a continuous blade. The continuous blade may be configured to move in a continuous loop in a conveyor system. In this way, the same cutting tool may be used to slice potatoes protruding from each receptacle. Providing a single cutting tool associated with each receptacle may reduce a cost and/or complexity of the apparatus, and/or improve an ease of maintenance of the apparatus

Optionally, the spaced array extends in a direction orthogonal to a direction of motion of each receptacle to form a row of receptacles. The continuous blade may be configured so that the cutting edge is substantially perpendicular to a direction of motion of each of the receptacles, in use. In this way, a potato protruding from the outlet of each receptacle may pass transversely over the cutting edge during a cutting stroke of the receptacle. This may improve a quality of the slice produced from the potato and/or reduce stresses on the cutting tool.

By providing the spaced array of receptacles, a rate of production of potato slices by the apparatus may be improved compared, for example, to providing a single receptacle. Moreover, such a spaced array may provide an improved distribution and/or separation of the potato slices on the conveyor, for instance so that there is no overlap of the potato slices on the conveyor. This may improve an efficiency of subsequent processes performed on the potato slices, such as washing, lipophilic conditioning, and/or dehydrating processes. In particular, by providing such a spaced array of receptacles, potato slices may be arranged in a corresponding spaced array on the conveyor. For instance, the spaced array may comprise the row of receptacles, and the potato slices may be spaced apart in corresponding rows on the conveyor, with the potatoes in each row being spaced apart from one another in correspondence with a spacing of the receptacles from one another.

Preferably, the potato slices in each row on the conveyor are evenly spaced apart from each other, and/or the rows of potato slices on the conveyor are evenly spaced apart from each other. This may be by the plurality of receptacles being evenly spaced apart in the row of receptacles, by each receptacle in the row of receptacles being caused reciprocate at a constant frequency, by the plurality of receptacles being caused to move in a synchronised reciprocating motion, so that the potatoes in each receptacle are caused to pass the cutting tool simultaneously, and/or by the conveyor being caused to move at a constant speed. Providing spaced and/or evenly spaced potatoes on the conveyor, may improve an ease of further conditioning and/or handling of the potato slices, such during as washing, lipophilic conditioning, and/or dehydrating processes, downstream of the apparatus. The plurality of receptacles may be caused to move at a constant frequency of up to 80, up to 90, up to 100, up to 110, up to 120, up to 130, or more than 140 reciprocations per minute.

Each receptacle may be spaced from adjacent receptacles so that potato slices in each row on the conveyor are spaced apart by at least 3 mm, at least 5 mm, preferably at least 8 mm, or at least 10 mm. The rows of potato slices may be spaced apart from each other in correspondence with the regular reciprocating motion of each receptacle and/or the speed of the conveyor, as noted above. The frequency of the reciprocating motion and/or the speed of the conveyor may be configured so that the rows of potatoes are spaced apart by at least 3 mm, at least 5 mm, preferably at least 8 mm, or at least 10 mm.

Alternatively, the potatoes may be arranged in any other suitable arrangement on the conveyor. For instance, the reciprocating motion of the plurality of receptacles may be such that potatoes in two or more of the receptacles pass the cutting tool at different times. This may result in a staggered arrangement of potatoes on the conveyor.

Optionally, each receptacle is orientated so that the potato is caused to protrude from the respective outlet due to the action of gravity, at least as the potato is caused to pass across the cutting tool.

In this way, a simplicity of the receptacles may be improved, such as by not requiring a mechanism for urging the potatoes towards and through the outlets. Each outlet may be located at an end of a respective receptacle, and each receptacle may comprise a respective inlet for receiving the potato, the inlet at an opposite end of the receptacle to the outlet. Each receptacle may be orientated so that the respective inlet is above the respective outlet as the potato is caused to pass across the slicer, and/or during a full range of motion of the receptacle. In this way, potatoes may be received in the inlets, in use, and may drop towards and protrude through the outlets due to the action of gravity. In this way, the inlets may be readily accessible, such as to allow personnel and/or a feed system to easily feed potatoes into the receptacles.

Optionally, each receptacle is configured to receive and retain (using the retainer) more than one potato in the receptacle, such as up to two potatoes, up to three potatoes, up to five potatoes, or more than five potatoes. This may be by each receptacle comprising a tube having a height and diameter so that potatoes received through the inlet are stackable in a single stack of potatoes in the tube. Each tube may be configured to receive potatoes that, when the potatoes are elongate, have a major axis that is larger than the diameter of the tube, and a minor axis that is smaller than or substantially equal to the diameter of the tube. This may ensure that a longitudinal dimension of a potato (i.e., along the semi-major axis) in the tube is aligned with an axis of the tube. This, in turn, may ensure that the potatoes are radially retained by the walls of each tube, in use, to reduce a radial movement of a potato in, and thereby reduce a likelihood of a potato being ejected from, the tube as the potato is sliced by the cutting edge. This may also allow the potatoes to move through each tube more easily, and/or may provide potato slices having a more consistent shape and/or thickness than, for example, potatoes positioned with their respective longitudinal axes orientated in different directions to those of other potatoes in the tube.

Optionally, the tubes have diameters of from 40 mm to 90 mm, such as to receive potatoes of between 40 mm and 90 mm in diameter. Optionally, the tubes have diameters outside of the range 40 mm to 90 mm. Optionally, each tube has the same diameter as each other tube, which may provide a simple arrangement. Optionally, two or more of the tubes have different diameters. Alternatively, or in addition, each tube is replaceable with another tube of a different size. Providing differently sized tubes and/or providing replaceable tubes may allow a variety of sizes of potato to be received in the tubes, which may reduce a cost associated with using potatoes of a particular size.

Optionally, each tube has a pattern on an internal surface thereof. Optionally, the pattern comprises equally circumferentially spaced protrusions which extend along a length of each tube. This may form a star-shaped pattern when viewed axially along each tube. The star-shaped pattern may have any number of points, such as up to 5, up to 7, up to 8 or up to 10 points. Alternatively, any other suitable pattern may be employed, such as raised bumps and/or rings on the internal surfaces of the tubes. In general, the pattern may comprise one or more protrusions on the internal surface of each tube. In any event, providing a pattern on the interior surface of each tube may reduce a surface area of each tube that is in contact with potatoes therein. This, in turn, may reduces a resistance to a motion of the potatoes through the respective tube, while restricting a radial motion and/or re-orientation of the potatoes in the tube during slicing. This may improve a consistency in a shape and/or thickness of potato slices produced using the slicer, such as by improving a consistency in an extent to which the potatoes protrude from each outlet during each cutting stroke. Alternatively, the internal surface of one or more of the tubes may be smooth, and absent any such pattern.

Optionally, the apparatus comprises a lubrication system opening into each receptacle, for supplying a lubricant into each receptacle. The lubricant may permit potatoes in the receptacle to move through the receptacle towards the outlet with greater ease. This may reduce a likelihood of potatoes becoming lodged in the receptacle, and/or may reduce a time during which a potato does not protrude from the outlet. This may, in turn, increase a yield by the apparatus, by increasing a likelihood that a potato is sliced on each cutting stroke of the receptacle. Optionally, the lubrication system is configured to supply water into the receptacle as the lubricant.

Optionally, the receptacles are movable in a pendulum motion. The receptacles may be pivotable around a pivot axis to provide the pendulum motion. This may provide a simple configuration requiring fewer moving parts than, for example, receptacles that are movable in a linear reciprocating motion. By providing such pivotably movable receptacles, the outlets, and potatoes protruding from the respective outlets, in use, may move in a substantially arcuate path during the reciprocating motion of the receptacles. Alternatively, the receptacles may be movable in a substantially linear reciprocating motion, so that the outlets, and the parts of the potatoes protruding from respective outlets, in use, may move in a substantially linear path.

In any event, the cutting edge may be arranged in a path taken by the parts of the potatoes protruding from the respective outlets, to cause the parts of the potatoes protruding from the respective outlets to be sliced by the cutting edge to produce the potato slices.

Optionally, the apparatus comprises one or more actuators configured to move the receptacles. The, or each, actuator may comprise a piston and/or a motor.

Optionally, the receptacles are configured to be movable in a synchronised reciprocating motion. That is, each receptacle may be configured to reach an extreme of its respective range of motion at the same time as each other receptacle, and/or may be configured so that potatoes protruding from respective outlets simultaneously cross a path taken by the cutting tool. This may be by the receptacles being physically coupled to each other, so that the receptacles move in their respective reciprocal motions synchronously, or in any other suitable way. In this way, a regular array of potato slices may be captured by the conveyor, with potatoes aligned in rows and columns on the conveyor. Any of these optional features may improve an ease of further conditioning and/or handling of the potato slices, such during as washing, lipophilic conditioning, and/or dehydrating processes, downstream of the apparatus.

Optionally, the array of receptacles comprises at least two receptacles comprising tubes having different diameters. This may allow differently-sized potatoes to be provided to respective tubes, such as to ensure that potatoes in respective tubes are longitudinally aligned with the respective tubes. As noted above, such alignment of a longitudinal axis of each potato with a longitudinal axis of a respective tube may ensure that the potatoes are radially retained by the walls of the tube, in use. This may reduce a radial movement of a potato in, and thereby reduce a likelihood of a potato being ejected from, the respective tube as the potato is sliced by the cutting edge. This may also allow the potatoes to move through the respective tubes more easily, and/or may provide potato slices having a more consistent diameter than, for example, potatoes positioned with their longitudinal axes in different directions to that of other potatoes. Providing differently-sized receptacles, or tubes, may allow a range of sizes of potato to be used, which may reduce cost and/or improve a variety of sizes of potato slice produced using the slicer, which may be more desirable to a consumer.

Alternatively, one or more of the receptacles may be moveable independently of one or more other receptacles. In other words, the motion of the one or more receptacles may be physically decoupled from the motion of the one or more other receptacles. This may allow a staggered array of potato slices to be provided on the conveyor, such as by ensuring potatoes in adjacent receptacles are sliced at different times. This may improve a spacing between the potato slices while providing or maintaining a close-packed nature of the potato slices, which may maintain or improve a rate of production of potato slices produced using the slicer.

Optionally, the retainer comprises an upper surface arranged to abut an end of a potato protruding from the outlet of each receptacle, and to guide each potato towards the cutting edge of the cutting tool during a cutting stroke of the reciprocating motion.

Each receptacle may be configured to move relative to the upper surface. In particular, the upper surface may be an upper surface of a stationary guide located adjacent to the cutting edge of the cutting tool. The upper surface may be a flat surface or a curved surface. The upper surface may be shaped so that a distance between the upper surface and a path taken by the outlet of each receptacle during movement of the receptacle is substantially constant. This may ensure that the potato protrudes from each outlet to the same extent along at least a part of a range of motion of the respective receptacle, which may improve a consistency in the shape and/or thickness of the potato slices produced using the slicer.

Providing a single such upper surface or guide for retaining the potatoes in each receptacle may provide a simpler construction than, for instance, providing individual upper surfaces or guides, or other types of retainers, for each receptacle.

Optionally, the apparatus comprises a gap between the upper surface and the cutting edge of the cutting tool, wherein a thickness of the potato slices produced by the apparatus depends on a size of the gap.

Optionally, the retainer, or at least a part thereof, such as the upper surface, is adjustable to vary the size of the gap. The upper surface may be moved closer to, or further away from, the cutting edge to respectively decrease or increase a size of the gap. The gap may represent a minimum distance between the upper surface and the cutting edge. Providing an adjustable retainer may provide a simpler way of adjusting the thickness of the potato slices, as opposed, for example, to moving the cutting tool and/or the receptacle relative to each other.

The retainer may be arranged relative to the cutting blade such that a thickness of potato slices obtained from a potato in one receptacle is the same as a thickness of potato slices obtained from a potato in each other receptacle. This may be by the gap, where provided, between the retainer and the cutting edge being constant along at least a part of a path taken by the cutting tool, the part of the path being a part across which potatoes protruding from each of the receptacles is caused to pass during the reciprocating motion of each receptacle. This may improve a consistency in a thickness of potato slices obtained from each receptacle. Optionally, as noted above, the retainer is adjustable. In particular, the retainer may be adjustable to control a thickness of potato slices obtained from potatoes in each receptacle, such as by adjusting a size of the gap, where provided. This may allow a thickness of the potato slices from potatoes in each receptacle to be controlled simultaneously by adjustment of the single retainer relative to the cutting tool. This may improve a simplicity and ease-of-use of the apparatus. The gap may have a size, and/or the potato slices may have a thickness of, up to 1.2 mm, up to 1.3 mm, up to 1.4 mm, up to 1.5 mm, up to 1.6 mm, up to 1.7 mm, up to 1.8 mm, or greater than 1.8 mm.

Optionally, the retainer is adjustable to adjust a distance between at least a part of the retainer and at least a part of a path taken by the outlet of each receptacle during motion of the receptacle. Optionally, the retainer is so adjustable to vary an extent to which the potato protrudes from the respective outlet, in use. Optionally, a distance between the cutting edge and the at least a part of the path taken by each outlet during the motion of the respective receptacle may be fixed. In this way, by adjusting the retainer relative to the receptacles, while maintaining a distance between the cutting edge and the receptacles, a thickness of the resulting potato slices may be varied. In other words, as noted above, the at least a part of the retainer may be adjustable to adjust the size of the gap between the upper surface, where provided, and the cutting edge, thereby to control a thickness of the potato slices. It may be more convenient to adjust the at least a part of the retainer to adjust a thickness of the potato slices, as opposed to, for example, varying the distance of the cutting edge from the at least a part of the path taken by each outlet during the motion of the respective receptacle.

A second aspect of the present invention provides a method of producing potato slices from a potato, the method comprising: receiving a potato in each receptacle of a spaced array of receptacles, each receptacle comprising an inlet and an outlet through which a respective potato can protrude; retaining, using a retainer, a potato in each receptacle so that the potato protrudes from the respective outlet; and causing movement of each receptacle in a reciprocating motion relative to a cutting tool, the cutting tool comprising a cutting edge for cutting the potato in each receptacle; wherein the causing movement of the receptacle causes a part of the potato protruding from each outlet to pass across the cutting edge so that the potato is sliced by the cutting edge to produce the potato slices.

In this way, as with the first aspect of the present invention discussed above, a series of potato slices may be produced from the potato. The potato slices may be aligned on the conveyor. In this way, an efficiency and/or effectiveness of subsequent processes on the potato slices, such as washing, lipophilic conditioning, and/or dehydrating processes.

The causing movement of the receptacle in the reciprocating motion may comprise causing movement of the receptacle in the reciprocating motion at a constant frequency, such as to produce a series of evenly-spaced potato slices on the conveyor, which may further improve an efficiency and/or effectiveness of the subsequent processes.

Optionally, the receptacles are evenly spaced, so as to produce an array of evenly spaced potato slices on the conveyor. Optionally, the spaced array extends in a direction orthogonal to the reciprocating motion of the receptacles, to form a row of receptacles. Optionally, the receptacles in the row are configured to move in a synchronous reciprocating motion, for instance by each receptacle being physically coupled to each other receptacle in the row.

Optionally, the reciprocating motion has a constant frequency, so as to produce a series of evenly-spaced rows of potato slices in the conveyor. Providing spaced and/or evenly spaced potatoes on the conveyor, may improve an ease of further conditioning and/or handling of the potato slices, such during as washing, lipophilic conditioning, and/or dehydrating processes performed on the potato slices.

Optionally, the causing movement of the receptacles comprises causing movement of the receptacles in a pendulum motion. This may provide a simple configuration requiring fewer moving parts than, for example, causing the receptacles to move in a linear reciprocating motion. Optionally, the causing movement of the receptacles comprises causing operation of one or more actuators configured to move the receptacles, such as one or more pistons and/or motors, such as to cause the receptacles to pivot around a pivot axis in the pendulum motion. The pivot axis may be a pivot axis common to each of the receptacles.

Optionally, the retainer is adjustable to adjust a size of a gap between the retainer and the cutting tool, and the method comprises adjusting the retainer to adjust the size of the gap. Adjusting the size of the gap may adjust the thickness of the potato slices. Adjusting the retainer to adjust the thickness of the potato slices may be simpler and easier than, for example, adjusting a distance of the cutting edge from a part of a path taken by the outlet during the motion of the receptacle.

Optionally, two or more of the receptacles in the array of receptacles are tubular and have different diameters, and wherein the receiving a potato in each receptacle comprises receiving respective potatoes of different diameters in the respective two or more receptacles.

Optionally, the method comprises sorting potatoes by size and supplying the potatoes to appropriately-sized receptacles. For instance, smaller potatoes may be supplied to and/or received in a receptacle that has a smaller diameter than another receptacle. This may ensure better alignment and retention of the potatoes in respective receptacles, as discussed above, which may reduce a likelihood of the potatoes being ejected from the respective receptacles as the potatoes are sliced by the cutting edge. Moreover, by sorting and receiving the potatoes in appropriately-sized receptacles, the potatoes may be able to move through the respective receptacles more easily, may stack better in the receptacles, and/or may improve a consistency in a thickness and/or diameter of potato slices produced by the method.

Optionally, the receptacles, the retainer, the cutting tool and/or the conveyor are a part of an apparatus. Optionally, the method is a method of producing potato slices from a potato using the apparatus. Optionally, the apparatus is the apparatus of the first aspect. It will be appreciated that the apparatus, and therefore the method of the second aspect, may comprise and/or benefit from any of the optional features and/or advantages of the first aspect.

A third aspect of the present invention provides a method of manufacturing potato crisps comprising: producing potato slices in accordance with the method of the second aspect; and cooking the potato slices to produce the potato crisps.

Optionally, the method comprises washing the potato slices to produce washed potato slices, and the cooking the potato slices comprises cooking the washed potato slices. Optionally, the method comprises performing lipophilic preconditioning of the washed potato slices to produce conditioned potato slices, and the cooking the potato slices comprises dehydrating the conditioned potato slices. Optionally, the performing lipophilic preconditioning of the washed potato slices is a part of the cooking process.

Optionally, the cooking the conditioned potato slices comprises baking, or frying, the potato slices according to known methods. Alternatively, the cooking the conditioned potato slices comprises dehydrating the potato slices, for example by microwaving the potato slice in a microwave and/or drying the potato slice in an oven, according to methods disclosed herein.

The method of the third aspect may comprise and/or benefit from any of the optional features and/or advantages of any of the first and/or second aspects.

A fourth aspect of the present invention provides a manufacturing line for manufacturing potato crisps, the manufacturing line comprising: the apparatus of the first aspect for producing potato slices; a washer configured to wash the potato slices to produce washed potato slices; a lipophilic conditioner configured to perform lipophilic conditioning of the washed potato slices to produce conditioned potato slices; and a dehydrator configured to dehydrate the conditioned potato slices to produce the potato crisps.

Optionally, the dehydrator comprises an oven for drying, or baking, the conditioned potato slices. Optionally, the dehydrator comprises a microwave for microwaving the conditioned potato slices to dehydrate the conditioned potato slices at least partially before drying. Optionally, the manufacturing line comprises a packaging apparatus configured to package the potato crisps, such as in bags.

It will be appreciated that the manufacturing line of the fourth aspect may comprise and/or benefit from any of the optional features and/or advantages of any of the first to third aspects.

A fifth aspect of the present invention provides an apparatus for washing and performing lipophilic preconditioning of a potato slice in the manufacture of a potato crisp, the apparatus comprising: a water bath into which water is receivable for washing the potato slice, and an oil bath into which oil is receivable for performing lipophilic preconditioning of the potato slice; and a belt assembly comprising an upper endless belt and a lower endless belt, the upper and lower endless belts defining a product flow path therebetween, the product flow path passing through the water bath and/or the oil bath; wherein the product flow path has a height, defined between lower and upper surfaces of the respective upper and lower endless belts, which is equal to or less than a thickness of the potato slices.

In this way, the lower and upper surfaces of the respective upper and lower endless belts may contact respective upper and lower surfaces of the potato slice simultaneously, in use. Thus, the potato slice may be firmly sandwiched between, and retained by, the upper and lower endless belts, in use. This may prevent, or reduce, a likelihood of the potato slice being displaced as it is passed through the water bath and/or the oil bath. This may be particularly advantageous to maintain a spacing between plural potato slices passing along the product flow path, thereby to increase a surface area of each potato slice that is in contact with water and/or oil in the respective water bath and/or oil bath, in use. This may improve an efficiency of washing and/or lipophilic preconditioning processes performed by passing the potato slices through the respective water bath and/or oil bath.

Optionally, the height of the product flow path is equal to or less than a maximum thickness of the potato slices. Optionally, the height of the produce flow path is equal to or less than an average, or median, thickness of the potato slices. This may ensure that potato slices which have a lower thickness than the maximum thickness are sufficiently retained between the upper and lower endless belts. Optionally, the height of the product flow path is equal to or less than a minimum thickness of the potato slices. This may ensure that even the thinnest potato slices are rigidly retained between the upper and lower endless belts.

Optionally, the water bath is at ambient temperature, but alternatively the water bath may be heated. Optionally, the belt assembly is a first belt assembly and the product flow path is a first product flow path passing through one of the water bath and the oil bath, and the apparatus comprises a second belt assembly defining a second product flow path passing through the other of the water bath and the oil bath. Optionally, the first and second product flow paths each have a height which is equal to or less than a maximum, or average, thickness of the potato slices. Alternatively, a product flow path passing through both the water bath and the oil bath may be defined by the same belt assembly. In either case, the advantages described above of firmly retaining the potato slices between upper and lower endless belts of the, or each, belt assembly may apply to both the washing and lipophilic conditioning processes.

Optionally, each of the upper and lower endless belts are driven belts. Optionally, each of the upper and lower endless belts are configured to be driven at the same speed. This may ensure that a position of the potato slice between the upper and lower endless belts is maintained as the potato slice passes along the product flow path. Optionally, the upper and lower endless belts of the belt assembly (or of a respective one of the first and second belt assemblies, where provided) can be driven at such a speed that the potato slice takes up to 25 s, up to 30 s, up to 40 s, up to 60 s, or greater than 60 s to pass through the water bath. Optionally, the upper and lower endless belts of the belt assembly (or of a respective one of the first and second belt assemblies, where provided), can be driven at such a speed that the potato slice takes up to 60 s, up to 70 s, up to 90 s, up to 100 s, or more than 100 s to pass through the oil bath, in use.

The apparatus may be configured so that the potato slice passes through the water bath before passing through the oil bath. This may ensure that the potato slice is washed, such as to remove starch from the potato slice, before the potato slice is passed through the oil bath for lipophilic preconditioning. A potato slice that has passed through the water bath may herein be referred to as a “washed potato slice”. A potato slice that has passed through the oil bath may be referred to as a “preconditioned potato slice”.

Optionally, the apparatus is configured to heat the oil in the oil bath to a temperature of from 85° C. to 95° C., such as from 88° C. to 92° C., such as 90° C. Reducing a temperature of the oil in the oil bath may increase a life of the resulting potato crisp, but may change certain organoleptic properties, such as texture, of the potato crisp.

Optionally, the apparatus comprises at least one air jet configured to apply a respective at least one jet of air to the potato slice in the product flow path downstream of the water bath. The at least one jet of air may cause excess water on a surface of the potato slice in the product flow path downstream of the water bath (i.e., the washed potato slice) to be removed. This may be referred to as a “de-watering” process and may reduce a total water content of the washed potato slice. This, in turn, may improve a quality of a potato crisp manufactured from the washed and lipophilic preconditioned potato slice produced using the apparatus.

Optionally, the apparatus comprises at least one air jet configured to apply a respective at least one jet of air to the potato slice in the product flow path downstream of the oil bath. The at least one jet of air may cause excess oil on a surface of the potato slice in the product flow path downstream of the oil bath (i.e., the preconditioned potato slice) to be removed. This may be referred to as a “de-oiling” process and may reduce a total oil content of the preconditioned potato slice. This, in turn, may improve a quality of a potato crisp manufactured from the washed and lipophilic preconditioned potato slice produced using the apparatus.

The apparatus may comprise plural air jets, each air jet configured to apply a respective jet of air to the potato slice in the product flow path downstream of the water bath and/or downstream of the oil bath. The plural air jets may be located above and/or below the product flow path, such as above the upper endless belt and/or below the lower endless belt. This may cause a jet of air to impinge on an upper surface of a potato slice in the product flow path, and another jet of air to impinge on a lower surface of the potato slice in the produce flow path, which may improve an amount of water and/or oil that is removed from the potato slice, in use.

Optionally, the upper and lower endless belts are oil-and water-permeable. This may allow the potato slice in the product flow path to be exposed to water and oil in the respective water and oil baths, in use. This may also allow the at least one jet of air from the respective at least one air jet, where provided, to impinge on the potato slice in the product flow path downstream of the water bath and/or the oil bath. This may improve a quality and/or efficiency of the washing, lipophilic conditioning, de-watering and/or de-oiling processes described above.

Optionally, the upper and lower endless belts comprise a mesh structure. Optionally, the upper and lower endless belts are wire mesh belts, comprising a plurality of interlinked wires, such as metal and/or polymer wires, forming a mesh structure. This may provide a robust yet flexible belt assembly for firmly retaining the potato slice in the product flow path whilst reducing a risk of damage to the potato slice. Moreover, the mesh structure may permit a greater surface area of the upper and lower surfaces of the potato slice to be exposed to the water in the water bath, the oil in the oil bath, and/or the at least one jet of air from the respective at least one air jet, where provided. Optionally, each of the upper and lower wire mesh belts has a total “open” area (i.e., an area between the interlinked wires) of up to 70%, up to 80%, up to 85%, or greater than 85% of the total area of the respective belt.

A sixth aspect of the present invention provides a method of washing and performing lipophilic preconditioning of a potato slice in the manufacture of a potato crisp, the method comprising: washing the potato slice by conveying the potato slice through a water bath to produce a washed potato slice; performing lipophilic preconditioning of the washed potato slice by conveying the potato slice through an oil bath comprising oil at a temperature of from 75° C. to 90° C., to produce a preconditioned potato slice; and conveying the potato slice through the water bath and/or through the oil bath along a product flow path defined between an upper endless belt and a lower endless belt; and wherein the product flow path has a height, defined between lower and upper surfaces of the respective upper and lower endless belts, which is equal to or less than a thickness of the potato slices.

In this way, as described above, the lower and upper surfaces of the respective upper and lower endless belts may contact respective upper and lower surfaces of the potato slice simultaneously, so as to firmly retain the potato slice between the upper and lower endless belts. This may prevent, or reduce a likelihood of, the potato slice moving location as it is passed through the water bath and/or the oil bath. This may, in turn, help to maintain a spacing between plural potato slices passing along the product flow path, which may improve an efficiency of washing and/or lipophilic preconditioning processes performed by passing the potato slices through the respective water bath and/or oil bath.

Optionally, the height of the product flow path is equal to or less than a maximum thickness of the potato slices. Optionally, the height of the produce flow path is equal to or less than an average, or median, thickness of the potato slices. This may ensure that potato slices which have a lower thickness than the maximum thickness are sufficiently retained between the upper and lower endless belts. Optionally, the height of the product flow path is equal to or less than a minimum thickness of the potato slices. This may ensure that even the thinnest potato slices are rigidly retained between the upper and lower endless belts.

Optionally, the method comprises passing the potato slice through one of the water bath and the oil bath along the product flow path, the product flow path being a first product flow path, and the upper and lower endless belts being respective first upper and lower endless belts. Optionally, the method comprises passing the potato slice through the other of the water bath and the oil bath along a second product flow path defined between respective second upper and lower endless belts. Optionally, the first and second product flow paths each have a height which is equal to or less than a maximum thickness of the potato slices. In either case, the advantages described above of firmly retaining the potato slices between upper and lower endless belts of the, or each, belt assembly may apply to both the washing and lipophilic conditioning processes.

Optionally, the water in the water bath is at an ambient temperature. Alternatively, the water in the water bath may be heated. Optionally, the method comprises conveying the potato slice through the water bath at a speed such that the potato slice takes up to 25 s, up to 30 s, up to 40 s, up to 60 s, or greater than 60 s to pass through the water bath. Optionally, this is by the method comprising driving the belt assembly (or a respective pair of the first and second lower and upper endless belts, where provided) at an appropriate speed. Optionally, the method comprises conveying the potato slice through the oil bath at a speed such that the potato slice takes up to 60 s, up to 70 s, up to 90 s, up to 100 s, or more than 100 s to pass through the oil bath. Optionally, this is by the method comprising driving the belt assembly (or a respective pair of the first and second lower and upper endless belts, where provided) at an appropriate speed.

Optionally, the method comprises applying at least one jet of air from a respective at least one air jet to the potato slice in the product flow path downstream of the water bath and/or downstream of the oil bath. The at least one jet of air may cause excess water and/or oil on a surface of the potato slice in the product flow path downstream of the water bath and/or oil bath. This may reduce a total water and/or oil content of the potato slice which, in turn, may improve a quality of a potato crisp manufactured from a washed and lipophilic preconditioned potato slice produced using the method.

It will be appreciated that the method of the sixth aspect may comprise and/or benefit from any of the optional features of, and/or advantages ascribed to, the apparatus of the fifth aspect.

A seventh aspect of the present invention provides a manufacturing line for manufacturing a potato crisp from a potato, the manufacturing line comprising: a slicer for slicing the potato to produce a potato slice; the apparatus of the fifth aspect for washing and performing lipophilic conditioning of the potato slice to produce a washed and preconditioned potato slice; and a dehydrator for dehydrating the washed and preconditioned potato slice to produce a dehydrated potato slice.

Optionally, the dehydrator comprises at least one microwave configured to reduce a moisture content of (i.e., dehydrate) the washed and preconditioned potato slice.

Optionally, the dehydrator comprises an oven for further dehydrating, drying, or baking the potato slices following the dehydrating the potato slices in the microwave.

Optionally, the slicer comprises the slicer of the first aspect of the present invention. It will be appreciated that the manufacturing line may benefit from any of the optional features of, and/or advantages ascribed to, the apparatus of the first aspect, the manufacturing line of the fourth aspect and/or the apparatus of the fifth aspect.

An eighth aspect of the present invention provides a method of manufacturing a potato crisp from a potato, the method comprising: slicing the potato to produce a potato slice; washing and performing lipophilic conditioning of the potato slice in accordance with the method of the sixth aspect to produce a washed and preconditioned potato slice; dehydrating the preconditioned potato slice to produce the potato crisp.

Optionally, the dehydrating the washed and preconditioned potato slice comprises microwaving the washed and preconditioned potato slice in one or more microwave stages to reduce a moisture content of the washed and preconditioned potato slice. Optionally, the microwaving the potato slice is performed before the drying the potato slice. Optionally, the microwaved potato slice has a moisture content of up to 4%, up to 5%, up to 6%, up to 8%, up to 10%, or greater than 10%.

Optionally, the dehydrating the washed and preconditioned potato slice comprises drying, or baking, the washed and preconditioned potato slice in an oven, such as at a temperature of up to 120 C, up to 130 C, up to 135 C, up to 140 C, or greater than 140 C. Optionally, the method comprises drying the washed and preconditioned potato slice in the over for up to 7 minutes, up to 7.5 minutes, up to 8 minutes, or greater than 8 minutes. Optionally, the drying the potato slice is performed after the microwaving the potato slice.

Optionally, the potato crisp has a moisture content or up to 1.4 wt. %, up to 1.6 wt. %, up to 1.8 wt. %, up to wt.2%, or greater than 2 wt. %, based on a total weight of the potato crisp. Optionally, the potato crisp has an oil content of up to 18 wt. %, up to16 wt. %, up to 15 wt. %, up to 14 wt. %, or up to 13 wt. %, based on a total weight of the potato crisp.

Optionally, the slicing the potato slice is performed in accordance with the method of the second aspect. It will be appreciated that the method of the eighth aspect may comprise and/or benefit from any of the optional features and/or advantages of the method of the second aspect, the method of the third aspect, and/or the method of the sixth aspect.

A ninth aspect of the present invention provides a method of manufacturing a potato crisp from a potato slice, the method comprising: performing lipophilic preconditioning of the potato slice by conveying the potato slice along a product flow path that passes through an oil bath comprising oil at a temperature of from 75° C. to 95° C., to produce a preconditioned potato slice; conveying the preconditioned potato slice along the product flow path from the oil bath to at least one air jet; de-oiling the preconditioned potato slice by applying at least one jet of air to the potato slice from a respective at least one air jet to produce a de-oiled potato slice; and dehydrating the de-oiled potato slice to produce the potato crisp; wherein the applying the at least one jet of air from the respective at least one air jet is the sole active de-oiling action performed between conveying the potato slice through the oil bath and dehydrating the de-oiled potato slice, and wherein the potato crisp comprises an oil content of up to 18 wt. %, based on the total weight of the potato crisp.

The applying the at least one jet of air as the sole active de-oiling action includes not applying water to the potato slice between conveying the potato slice through the oil bath and dehydrating the de-oiled potato slice. The method provides a potato crisp comprising an oil content of up to 18 wt. % when the jet of air is the sole de-oiling action performed prior to dehydrating the potato crisp. This may provide a simpler and/or cheaper way of producing potato crisps having an oil content of up to 18 wt. % than, for example, spraying the preconditioned potato slices with water prior to applying the jet of air. The oil removed from the preconditioned potato slice by the air jet may be recirculated back into the oil bath.

The method may comprise providing the jet of air from a nozzle of the air jet at a velocity of up to 50 ms⁻¹, up to 80 ms⁻¹, up to 100 ms⁻¹, up to 110 ms⁻¹, up to 130 ms⁻¹ or greater than 130 ms⁻¹. This may be by the method comprising setting a speed of a motor configured to drive a fan to supply an airflow to the nozzle. The method may comprise varying a velocity of air provided from the nozzle.

Optionally, the method comprises determining an oil content of potato slices downstream of the de-oiler. This may be by periodically retrieving and testing a sample of the potato slices downstream of the de-oiler, such as at a period of up to 15 minutes, up to 30 minutes, up to 60 minutes, or greater than 60 minutes. Optionally, the method comprises varying the velocity of air provided from the nozzle and/or varying a conveying speed at which the potato slice is conveyed through the air jet based on the determined oil content. This may be to achieve a desired setpoint oil content. For instance, if the determined oil content is higher than the setpoint oil content, the method may comprise increasing the velocity of the air jet and/or reducing the conveying speed. Increasing a velocity of the air jet and/or increasing a duration during which the preconditioned potato slice is affected by the air jet, may increase an amount of oil removed from the preconditioned potato slice by the jet of air. Conversely, if the determined oil content is lower than the setpoint oil content, the method may comprise reducing the velocity of the air jet and/or increasing the conveying speed. Varying the velocity of the air jet may comprise operating a motor at different speeds, such as a motor that drives a fan to provide an airflow to the nozzle.

Optionally, the potato crisp comprises an oil content of up to 15 wt. %, up to 13 wt. %, up to 12 wt. %, up to 11 wt. %, or up to 10 wt. %, based on a total weight of the potato crisp. This may provide a crisp that has less than 50% of the fat of a typical purely fried potato crisp, while providing improved organoleptic properties such as taste and texture. Optionally, the oil in the oil bath is at a temperature of from 85° C. to 95° C., such as from 88° C. to 92° C., such as 90° C. Reducing a temperature of the oil may increase a life of the resulting potato crisp, but may change certain organoleptic properties, such as texture, of the potato crisp. Optionally, the method comprises applying the at least one jet of air to the preconditioned potato slice no later than 12 seconds from last contact of the preconditioned potato slice with oil in the oil bath.

Reducing a time taken to pass the preconditioned potato slice from the oil bath to the at least one air jet may increase an amount of oil that can be removed from the preconditioned potato slice by the jet of air, thereby reducing an amount of oil comprised in a potato crisp produced by dehydrating the de-oiled potato slice. For instance, the sooner the jet of air is applied to the preconditioned potato slice, the higher a temperature of the oil on the preconditioned potato slice may be when the jet of air is applied. Oil at a higher temperature may have a lower viscosity, and so may flow more easily, and be more readily removed from the preconditioned potato slice when exposed to a shear force provided by the jet of air.

Optionally, the method comprises applying the at least one jet of air no later than 10 seconds, 8 seconds, 5 seconds, 4 seconds, 3 seconds, or 2 seconds from last contact of the preconditioned potato slice with oil in the oil bath.

Optionally, the method comprises applying the jet of air before the preconditioned potato slice reduces in temperature by 10° C. from last contact of the preconditioned potato slice with oil in the oil bath.

As noted above, the higher the temperature of the oil on the potato slice when the jet of air is applied to the potato slice, the lower the viscosity of the oil is likely to be. As such, reducing an amount by which the temperature of the preconditioned potato slice reduces as the preconditioned potato slice passes from the oil bath to the air jet may increase an amount of oil that can be removed from the preconditioned potato slice by application of the jet of air. Optionally, the method comprises applying the jet of air before the preconditioned potato slice reduces in temperature by up to 10° C., up to 8° C., up to 6° C., preferably up to 5° C., up to 4° C., up to 3° C., up to 2° C., or up to 1° C.

Optionally, the product flow path is defined between an upper endless belt and a lower endless belt, and wherein the product flow path has a height, defined between lower and upper surfaces of the respective upper and lower endless belts, which is equal to or less than a maximum thickness of the potato slices.

In this way, the potato slice may be firmly sandwiched between the upper and lower endless belts, in use. This may prevent, or reduce a likelihood of, the potato slice moving relative to the upper and lower endless belts, and/or relative to or other potato slices in the product flow path, as the potato slice is passed through the oil bath and/or as the jet of air is applied to the preconditioned potato slice. This may advantageously maintain a spacing between plural potato slices in the flow path (e.g., to limit or prevent overlapping of the potato slices), which may in turn increase a surface area of each potato slice that is exposed to the oil in the oil bath and/or exposed to the jet of air. This may, in turn, increase an amount of oil that can be removed from the preconditioned potato slice by the jet of air.

Optionally, the method comprises applying plural jets of air to the preconditioned potato slice from respective plural air jets. This may improve an amount of oil that is removed from the preconditioned potato slice during the de-oiling process. Optionally, the plural jets of air are applied to the preconditioned potato slice simultaneously, such as from above the upper belt and below the lower belt. This may ensure that both upper and lower sides of the potato slice are exposed to at least one jet of air, which may increase an amount of oil removed. Alternatively, or in addition, the plural jets of air are applied one after the other as the preconditioned potato slice passes along the product flow path. Optionally, the potato slices are conveyed in a row or each jet of air is applied across a width

A tenth aspect of the present invention provides a method of manufacturing a potato crisp from a potato slice, the method comprising: performing lipophilic preconditioning of the potato slice by conveying the potato slice along a product flow path that passes through an oil bath comprising oil at a temperature of from 75° C. to 95° C., to produce a preconditioned potato slice; and dehydrating the preconditioned potato slice to produce the potato crisp; wherein no water is applied to the potato slice between conveying the potato slice through the oil bath and dehydrating the preconditioned potato slice, and wherein the potato crisp comprises an oil content of up to 18 wt. %, based on the total weight of the potato crisp.

Optionally, the method comprises de-oiling the preconditioned potato slice by applying at least one jet of air to the potato slice from a respective at least one air jet to produce a de-oiled potato slice. Optionally, the applying the at least one jet of air from the respective at least one air jet is the sole active de-oiling action performed between conveying the potato slice through the oil bath and dehydrating the de-oiled potato slice. It will be appreciated that the method of the tenth aspect may comprise and/or benefit from any of the optional features of the ninth aspect.

Optionally, the method of the ninth aspect and/or the method of the tenth aspect comprises slicing the potato slices in accordance with the method of the second aspect. Optionally, the method of the ninth aspect and/or the method of the tenth aspect comprises washing the potato slices. Optionally, the washing (where provided) and performing lipophilic preconditioning in the ninth and/or tenth aspects is performed in accordance with the method of the sixth aspect. It will be appreciated that the methods of the ninth and/or tenth aspects may comprise and/or benefit from any of the optional features and/or advantages of the method of the second aspect, the method of the third aspect, the method of the sixth aspect, and/or the method of the eighth aspect.

An eleventh aspect of the present invention provides a manufacturing line for manufacturing a potato crisp from a potato slice, the manufacturing line comprising: a product flow path along which the potato slice is passable through the manufacturing line; an oil bath through which the product flow path passes, the oil bath being for performing lipophilic preconditioning of the potato slice to produce a preconditioned potato slice; at least one air jet configured to apply a jet of air to the preconditioned potato slice in the product flow path downstream of the oil bath to produce a de-oiled potato slice; and a dehydrator for dehydrating the de-oiled potato slice to produce the potato crisp; wherein the at least one air jet is the sole apparatus in the manufacturing line for actively de-oiling the preconditioned potato slice before dehydrating; and wherein the manufacturing line is configured to produce a potato crisp comprising an oil content of up to 18 wt. %, based on the total weight of the potato crisp.

The at least one air jet being the sole apparatus in the manufacturing line for actively de-oiling the preconditioned potato slice includes the manufacturing line being absent any applicator for applying water to the potato slices between the oil bath and the dehydrator. Optionally, the dehydrator comprises a microwave for at least partially dehydrating (i.e., by microwaving) the de-oiled potato slices in the product flow path. Optionally, the dehydrator comprises an oven for drying, or baking, the preconditioned potato slice.

Optionally, the product flow path is configured to accommodate plural potato slices spaced apart from each other across a width of the product flow path, orthogonal to a direction of motion of the potato slices in the product flow path. Optionally, the at least one air jet comprises an elongate nozzle extending across at least a part of the width of the product flow path, so that the jet of air is applied to plural potato slices that are spaced apart across the width of the product flow path, in use. This may improve a capacity of the manufacturing line and/or increase an amount of oil removed from potato slices by the air jet.

A twelfth aspect of the present invention provides a manufacturing line for manufacturing a potato crisp from a potato slice, the manufacturing line comprising: a product flow path along which the potato slice is passable through the manufacturing line; an oil bath through which the product flow path passes, the oil bath being for performing lipophilic preconditioning of the potato slice to produce a preconditioned potato slice; and a dehydrator for dehydrating the de-oiled potato slice to produce the potato crisp; wherein the manufacturing line is absent any applicator for applying water to the potato slices between the oil bath and the dehydrator; and wherein the manufacturing line is configured to produce a potato crisp comprising an oil content of up to 18 wt. %, based on the total weight of the potato crisp.

Optionally, the manufacturing line comprises at least one air jet configured to apply a jet of air to the preconditioned potato slice in the product flow path downstream of the oil bath to produce a de-oiled potato slice. Optionally, the at least one air jet is the sole apparatus in the manufacturing line for actively de-oiling the preconditioned potato slice in the product flow path upstream of the dehydrator. It will be appreciated that the manufacturing line of the twelfth aspect may comprise and/or benefit from any of the optional features and/or advantages of the manufacturing line of the eleventh aspect.

Optionally, the manufacturing line of the eleventh aspect and/or the manufacturing line of the twelfth aspect comprises a slicing apparatus for producing the potato slices. Optionally, the slicing apparatus comprises the apparatus of the first aspect. Optionally, the manufacturing line of the eleventh aspect and/or the manufacturing line of the twelfth aspect comprises a water bath for washing the potato slices in the product flow path upstream of the oil bath. Optionally, the manufacturing line of the eleventh aspect and/or the manufacturing line of the twelfth aspect comprises the apparatus of the fifth aspect, wherein the water bath of the eleventh and/or twelfth aspects is the water bath of the fifth aspect, and the oil bath of the eleventh and/or twelfth aspects is the oil bath of the fifth aspect.

It will be appreciated that the manufacturing line of the eleventh aspect and/or the manufacturing line of the twelfth aspect may comprise and/or benefit from any of the optional features and/or advantages of the apparatus of the apparatus of the first aspect, the manufacturing line of the fourth aspect, the apparatus of the fifth aspect, the manufacturing line of the seventh aspect, the method of the ninth aspect and/or the method of the tenth aspect.

A thirteenth aspect of the present invention provides a method of producing a bag of potato crisps, comprising manufacturing potato crisps according to the method of any one of the third, eighth, ninth and tenth aspects, and packaging the potato crisps into a bag. It will be appreciated that the method of the thirteenth aspect may benefit from any of the optional features of, and/or advantages ascribed to, any of the third, eighth and/or ninth aspects.

A fourteenth aspect of the present invention provides a potato crisp manufactured according to the method of any one of the third, eighth, ninth and tenth aspects, optionally wherein the crisp is packaged into a bag according to the method of the thirteenth aspect. It will be appreciated that the potato crisp of the fourteenth aspect may benefit from any of the optional features of, and/or advantages ascribed to, any of the third, eighth, ninth, tenth and/or twelfth aspects.

It will be appreciated that optional features of any of the above aspects of the present invention may be equally applied to other aspects of the present invention, where appropriate. In particular, the present disclosure provides three primary aspects for use in methods, apparatus, and manufacturing lines for producing potato crisps, these embodiments including slicing potatoes, washing/performing lipophilic preconditioning of potato slices, and de-oiling potato slices. These aspects may be combined in any suitable way, as will be evident from the description and drawings, which describe and show an example manufacturing line and process for manufacturing potato crisps.

### BRIEF DESCRIPTION OF DRAWINGS

Embodiments of the invention will now be described, by way of example only, with reference to the accompanying drawings, in which:

FIG. 1 is a schematic view of an example manufacturing line for manufacturing potato crisps;

FIG. 2 is a schematic side view of an example slicer for producing potato slices from potatoes in the manufacturing line of FIG. 1;

FIG. 3 is a schematic frontal view of the slicer of FIG. 2;

FIG. 4 is a schematic top view of a conveyor comprising potato slices produced using the slicer of FIGS. 2 and 3;

FIG. 5 is a schematic cross-sectional view along an axis of two receptacles of the slicer of FIGS. 2 and 3;

FIG. 6 is a schematic side view of an example washer for washing potato slices in the manufacturing line of FIG. 1;

FIG. 7 is a schematic side view of an example conditioner for performing lipophilic preconditioning of potato slices in the manufacturing line of FIG. 1;

FIG. 8 is a schematic side view of an example de-oiler for removing oil from potato slices in the manufacturing line of FIG. 1;

FIG. 9 shows a flow chart of a method of producing potato crisps from a potato; and

FIG. 10 shows a flow chart of a method of producing a bag of potato crisps.

### DETAILED DESCRIPTION

The following description presents exemplary embodiments and, together with the drawings, serves to explain principles of embodiments of the invention. In particular the following description describes a full process of manufacturing potato crisps, which includes embodiments disclosed in the preceding Summary section.

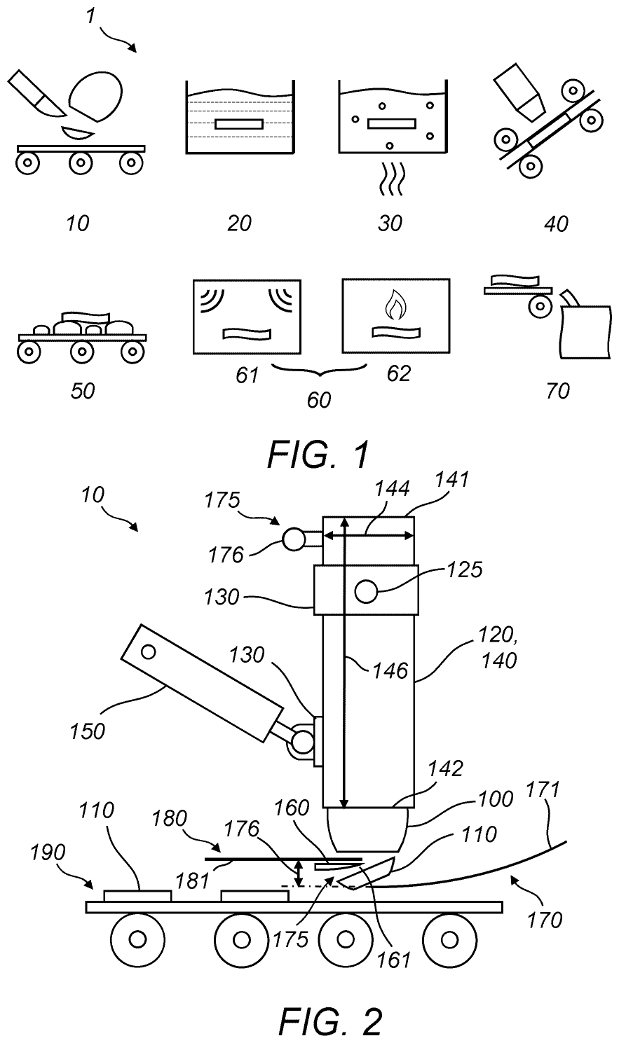

FIG. 1 shows a schematic diagram of a manufacturing line 1 for performing a method of manufacturing potato crisps. The manufacturing line 1 comprises a slicer 10, a washer 20, a conditioner 30, a de-oiler 40, a shaping belt 50, a dehydrator 60 comprising a microwave 61 and an oven 62, and a packager 70. It is noted that the following description shows only one implementation of the manufacturing line 1, which is not to be construed as limiting in respect of the specific number, arrangement, and/or type of component or processes described. It will be apparent to the skilled artisan that one or more of the components or processes described herein may be omitted, and/or other components not described herein may be provided, without departing from the scope of the invention as defined in the appended claims.

As will be described in more detail below with reference to further figures, the slicer 10 of the manufacturing line 1 receives and slices potatoes 100 into potato slices 110, which are then captured on a conveyor 190 which forms a part of a product flow path 800 through the manufacturing line 1. The potato slices 110 are conveyed to the washer 20, which comprises a water bath 210. The potato slices 110 are submerged in and passed through the water bath 210 to remove starch from the potato slices 110. The potato slices 110 are then removed from the water bath 210 and dried using a blower (not shown in FIG. 1) to produce washed potato slices 110 (for ease of understanding, we here use the same reference numeral 110 for potato slices 110 at any stage in the manufacturing line 1).

The washed potato slices 110 are passed to the conditioner 30, which comprises a heated oil bath 310. The washed potato slices 110 are submerged in and passed through the heated oil bath 310 to perform lipophilic pre-conditioning of the washed potato slices 110 and produce preconditioned potato slices 110. The lipophilic pre-conditioning process changes the organoleptic properties of the potato slices 110, such as by inactivating enzymes that cause undesirable flavours and/or gelatinising native starch with native water in the potato slices 110 to alter a texture of the potato slice.

The preconditioned potato slices 110 are passed through the de-oiler 40. The de-oiler 40 applies at least one jet of air 371 to the preconditioned potato slice 110 to cause excess oil on a surface 111, 112 of the preconditioned potato slice 110 to be removed, to produce a de-oiled potato slice 110. The de-oiled potato slice 110 is then passed along the product flow path 800 to the shaping belt 50, which comprises a polymeric band having an undulating surface.

The potato slices are then passed into the dehydrator 60, which comprises a primary microwave 61 and a deep bed microwave (not shown). The potato slices 110 are dehydrated, optionally rapidly or explosively, by operation of the primary microwave to reduce a moisture content of the potato slices 110. This improves a rigidity of the potato slices 110 by simulating a dehydration rate of a frying process. The potato slices are carried into the primary microwave on the shaping belt 50. The shaping belt 50 causes the potato slices 110 to change shape in the primary microwave, such as to conform, at least in part, to the shape of the undulating surface. This may improve a visual and/or tactile appeal of the potato slice 110 and resulting potato crisp.

The potato slices 110 are then passed to the deep bed microwave for further, more gradual, dehydration and/or drying. The deep bed microwave comprises trays for receiving the potato slices in piles of potato slices 110. The piles are typically two-to-three potato slices high. The trays of potato slices 110 are then passed to the oven 62 which further dehydrates, such as to cook and/or bake the potato slices 110, to produce potato crisps. The oven 62 causes the potato crisps to take on a final colour and texture. Finally, the potato crisps are passed to the packager 70, which packages the crisps into a crisp packet or other suitable container.

Components of the manufacturing line 1 are described below in more detail, in the order shown in FIG. 1.

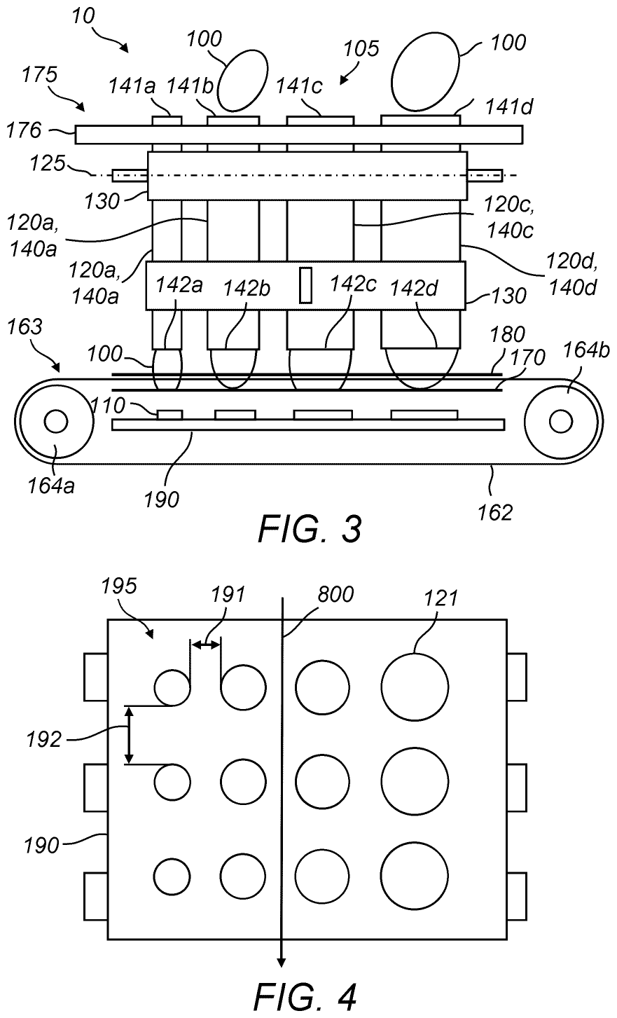

FIGS. 2 and 3 show schematic front and side views, respectively, of the slicer 10. The slicer 10 comprises a spaced array 105 of receptacles 120. The spaced array 105 comprises first to fourth receptacles 120a, 120b, 120c, 120d (herein collectively referred to using the reference numeral 120). The receptacles 120 are physically coupled to one another by a coupler 130 and are moveable together in a reciprocating motion about a common axis 125 of rotation. The reciprocating motion is imparted by a piston 150 coupled to the receptacles 120 via the coupler 130, but in other examples may be imparted by any other suitable actuator. The receptacles 120 are coupled together by the coupler 130 in such a way that the array 105 extends in a direction orthogonal to the direction of reciprocating motion of the receptacles 120. It will be appreciated that any other suitable number of receptacles 120 may be provided in other examples, such as up to 3, or more than 4 receptacles 120.

Each receptacle 120 comprises a tube 140 comprising a respective inlet 141a, 141b, 141c, 141d (collectively 141) for receiving a potato 100 and a respective outlet 142a, 412b, 142c, 142d (collectively 142) through which the potato 100 can protrude. The receptacles 120 are each configured to receive and retain (using a retainer described below) more than one potato 100 in the respective tube 140, such as up to or more than four potatoes 100. Specifically, the tubes 140 each have a height 144 and diameter 146 so that potatoes received in the tube 140 are stackable in a single stack of potatoes in the tube 140. The tubes 140 each have different diameters 146, wherein the smaller-diameter tubes 140 are configured to receive smaller potatoes 100 than the larger-diameter tubes 140 are configured to receive. In particular, the diameters 146 of adjacent tubes increase progressively from the first to fourth tubes 140a, 140b, 140c, 140d. In use, potatoes 100 are distributed into appropriately-sized tubes 140 so that a longitudinal dimension of each potato 100 (where the potatoes are elongate) is larger than a diameter 146 of a tube 140 into which it is inserted. This ensures that a longitudinal dimension of each potato 100 in a tube 140 is orientated mostly axially along the tube 140, which in turn reduces a radial movement and/or re-orientation of the potato 100 in the tube 140 during slicing.

The slicer 10 comprises a cutting tool 160 comprising a cutting edge 161 for cutting the potatoes 100 protruding from the respective outlets 142. The cutting edge 161 is formed by a band blade 162 which moves in a continuous loop 163 around a set of pulleys 164a, 164b. The band blade 162 is arranged so that the cutting edge 161 extends along, and moves, in a direction orthogonal to a direction of motion of the receptacles 120. In this way, as the receptacles 120 move in the reciprocating motion about the axis 125, the potatoes 100 protruding out of respective outlets 142 are caused to pass substantially perpendicularly across the cutting edge 161. This causes the potatoes 100 to be sliced by the cutting edge 161 to produce potato slices 110, specifically skin-on potato slices 110, which are then captured by the conveyor 190 located below the cutting tool 160.

A weight of the potatoes in each stack urge a lowermost potato towards a respective outlet 142. In this way, the potatoes are gravity-fed through the receptacles 120, so that a lower-most potato 100 in a stack of potatoes 100 in each tube 140 is urged to protrude from the respective outlet 142 by the weight of other potatoes in the stack. The slicer 10 comprises a retainer 170, for limiting an extent to which the potatoes 100 protrude from the outlet 142 of each receptacle 120. As best shown in FIG. 2, the retainer 170 comprises an upper surface 171 arranged to abut an end of the potatoes 100 protruding from the respective outlets 142 and to guide the potatoes 100 towards the cutting edge 161 of the cutting tool 160 during a cutting stroke of the reciprocating motion of the receptacles 120. The cutting stroke is defined herein as a portion of the reciprocating motion that moves the potatoes 100 in the receptacles 120 from right to left in FIG. 2, to cause the potatoes to move towards and across the cutting edge 161. A retraction stroke is defined herein as a portion of the reciprocating motion that moves the potatoes 100 in the receptacles 120 from left to right in FIG. 2, from the end of one cutting stroke to the start of the next cutting stroke.

The retainer 170 is shaped so as to conform to a path taken by the outlets 142 during the cutting stroke. Specifically, the upper surface 171 of the retainer 170 is arcuate. This ensures that the potatoes 100 protrude from the respective outlets 142 to a substantially constant degree as they are passed towards the cutting edge 161. The upper surface 171 of the retainer 170 is spaced from the cutting edge 161 of the cutting tool 160 to form a gap 175 between the upper surface 171 and the cutting edge 161. In this way, during the cutting stroke, a potato 100 in each receptacle 120 is guided towards the cutting edge 161 along the upper surface 171. The cutting edge 161 then contacts the respective potato 100 at a distance above the upper surface 171 corresponding to a size 176 of the gap 175. In this way, a thickness of the resulting potato slice 110 depends on the size of the gap 175.

As the potato 100 continues across the cutting edge 161, the potato slice 110 passes through the gap 175, while the freshly-cut lower surface of the remaining potato passes along a support 180 above the cutting tool 160. The band blade 162 extends along a lower surface 181 of the support 180, and in some examples extends through a slot (not shown) in the lower surface 181 of the support 180, so that the lower surface of the remaining potato can pass smoothly from the cutting edge to the support 180. In this way, the support 180 acts as a guard to prevent the potatoes 100 from exerting a downward force along a surface of the band blade 162 following cutting by the cutting edge 161. In other words, the band blade 162 itself need not support the weight of potatoes 100 stacked in the receptacles 120. This may prevent flexing of the band blade 162 and/or improve a longevity of the cutting tool 160. The support 180 shown in FIGS. 2 and 3 is flat. In other examples, however, the support 180 may conform to a path taken by the outlets 142 in the reciprocating motion, as with the retainer 170.

The potato slices 110 produced by the slicer 10 pass through the gap 175 and onto the conveyor 190 located below the gap 175. The conveyer 190 is caused to move at a constant speed, to cause the potato slices 110 to move away from the slicer 10 along the product flow path 800 at a constant speed. By arranging the receptacles 120 in the spaced array 105, causing the receptacles 120 in the spaced array 105 to move in the reciprocating motion relative to the cutting tool 160, and causing the conveyor 190 to move at a constant speed, a correspondingly-spaced array 195 of potato slices 110 is provided on the conveyor 190. That is, as best shown in FIG. 4, which is a top-down view of the potato slices 110 on the conveyor 190, the potato slices 110 are spaced apart along a width of the conveyor by a width spacing 191, and along a length of the conveyor 190 by a length spacing 192. The width spacing 191 can be increased or decreased by spacing the receptacles 120 in the array 105 of receptacles 120 respectively farther apart or closer together. The length spacing 192 can be increased by increasing a speed of the conveyor and/or by decreasing a frequency of the reciprocating motion of the receptacles 120. Alternatively, the length spacing 192 can be decreased by decreasing the speed of the conveyor 190 and/or by increasing the frequency of the reciprocating motion of the receptacles 120.

The width spacing 191 between each potato in each row (along the width of the conveyor 190) is here shown as being constant, for simplicity. Similarly, the length spacing 192 between each potato 100 in each column (along the length of the conveyor 190) is shown as being constant. However, it will be appreciated that, in reality, a size of the potato slices 110 in each row and column will depending on a number of factors, including: which part of a potato was used to produce the potato slice; the actual size of the potato; and the specific orientation of the potato in a corresponding receptacle. For instance, an end of a potato will produce smaller-diameter potato slices 110 than a middle portion of the potato. Moreover, in some examples, a spacing between the receptacles 120 may vary. Nevertheless, the receptacles 120 are spaced apart, and the speed of the conveyor and frequency of the reciprocating motion are set, so that an average spacing between each potato slice (i.e., an average width spacing 191 and an average length spacing 192) is at least 8 mm. A capacity of the manufacturing line 1 can be increased by reducing the spacing of potato slices 110 on the conveyor 190. On the other hand, an efficiency of subsequent processing, such washing in the washer 20 and/or lipophilic conditioning in the conditioner 30, may be improved by increasing the width and/or length spacing 191, 192 of the potato slices 110 on the conveyor 190.

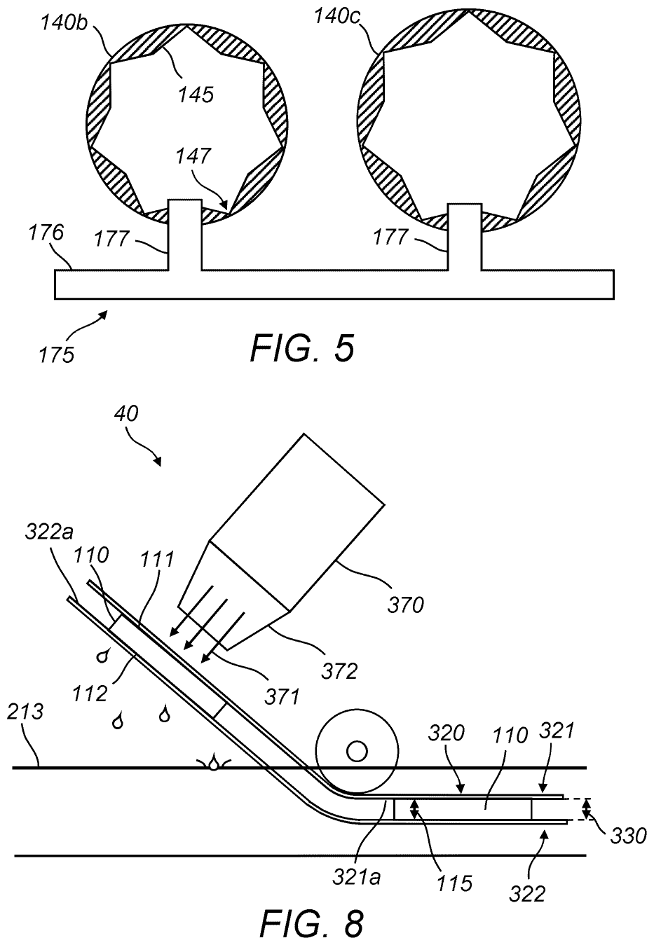

As best shown in FIG. 5, which shows a top-down schematic view through two of the receptacles 120b, 120c, each tube 140 has a pattern 145 on an internal surface 147 thereof. In the example shown, the pattern 145 comprises equally circumferentially spaced protrusions which extend along a length of the tube 140. This forms a star-shaped pattern 145 when viewed axially along the tubes 140, as in FIG. 5. This shape reduces a surface area of each tube 140 that is in contact with potatoes therein. This, in turn, reduces a resistance to a motion of the potatoes 100 through the respective tube 140, while still restricting a radial motion and/or re-orientation of the potatoes 100 in the tube 140 during slicing. This may improve a consistency in a shape and/or thickness of potato slices 110 produced using the slicer 10, such as by improving a consistency in an extent to which the potatoes 100 protrude from each outlet 142 during each cutting stroke. It will be appreciated that, in other examples, any other suitable pattern 145 may be employed, such as raised bumps and/or rings on the internal surfaces 147 of the tubes 140. In other examples, the internal surface 147 of one or more of the tubes 140 is smooth, and absent any pattern 145.

As also shown in FIGS. 2 to 4, the slicer 10 comprises a lubrication system 175 to aid motion of the potatoes through the tubes 140. The lubrication system 175 comprises a common channel 176 and first to fourth taps (together referred to with the reference numeral 177) fluidically connecting the common channel 176 to tubes 140 of the respective first to fourth receptacles 120. The common channel 176 is connected to a source of lubricant, which here is water. The water passes through the common channel 176 and into the tubes 140 via the respective taps 177, to lubricate the internal surfaces 147 of the tubes 140. This further reduces a resistance to motion of the potatoes 100 through the tubes 140, which may prevent clogging and/or may improve a consistency in the shape of the potato slices 110 produced using the slicer 10, as described above. In some examples, a manually-operated tool (not shown), such as a mallet or pneumatic gun, is used to urge the potatoes 100 along a respective tube 140

In the present example, opposing ends of each potato 100, in a longitudinal dimension of the potato 100, are removed, such as manually using a knife, prior to insertion of the potato 100 into a respective tube 140. In this way, both upper and lower surfaces of each potato slice 110 produced from a potato by the slicer 10 may be absent any potato skin, or may comprise a reduced amount of potato skin, than if the ends of the potato 100 were not removed. This may improve an efficiency of the downstream washing, lipophilic preconditioning, and/or dehydrating processes, by ensuring a greater proportion of the interior of each potato slice 110 is exposed to the water, oil, and/or atmosphere in the microwave or oven. Pre-slicing the potatoes 100 in this way may also ensure that upper and lower surfaces of the potato slices 110 are substantially flat, so as to provide improved retention and/or stability of the potato slices 110 on the conveyor 190.

The conveyor 190 is configured to pass the potato slices 110 from the slicer 10 to the washer 20 along the product flow path 800. While not shown here, intermediate conveyors or other components for moving the potato slices 110 may be provided in the product flow path 800 between the conveyor 190 and the washer 20, or indeed between any other components of the manufacturing line 1 described herein.

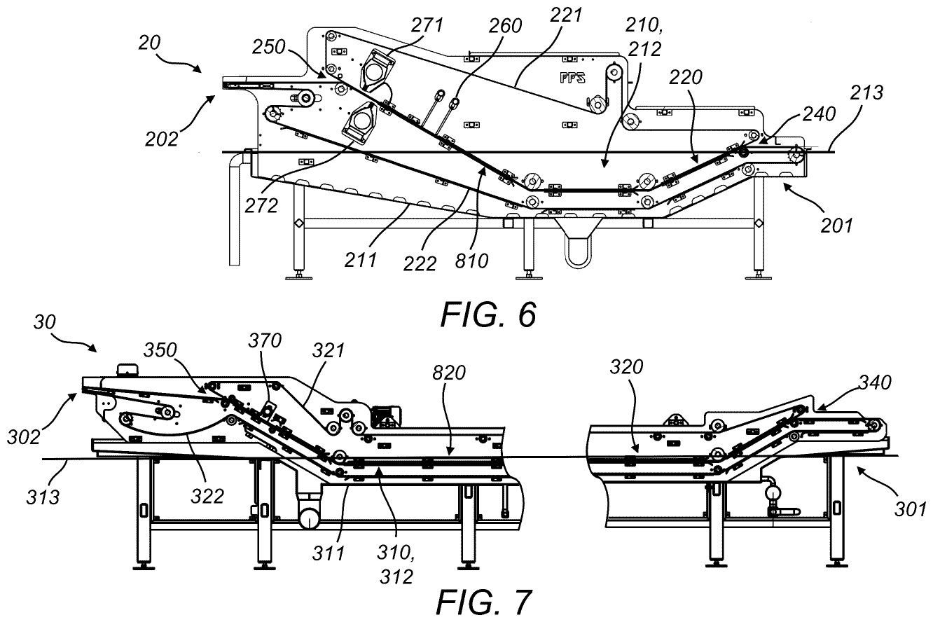

The washer 20, as shown in FIG. 6, comprises a water bath 210, which comprises a washer reservoir 211 containing water 212 at a water level 213. The water 212 is here at room temperature, but in other examples may be heated. The washer comprises a washer belt assembly 220, which comprises an upper endless washer belt 221 and a lower endless washer belt 222 defining a washer part 810 of the product flow path 800 therebetween. The upper and lower endless washer belts are arranged so that the washer part 810 of the product flow path has a height, defined between a lower surface of the upper endless washer belt 221 and an upper surface of the lower endless washer belt 222, that is less than a thickness 115 of the potato slices 110. This improves a retention of the potato slices 110 in the washer part 810 of the product flow path 800, which reduces a likelihood of displacement of the potato slices 110 as they are passed through the water bath 210. Here, the thickness 115 of the potato slices 110 is an average thickness of the potato slices 110 in the product flow path 800. In other examples, this may be a maximum or minimum thickness of the potato slices 110 in the product flow path 800.

The potato slices 110 are received on the upper surface of the lower endless washer belt 222 from the conveyor 190 at a first end 201 of the washer 20. The potato slices 110 are then entrained in the washer part 810 of the product flow path 800 and gripped between the upper and lower endless washer belts 221, 222 at a washer entrainment point 240 upstream of the water bath 210. The potato slices 110 are then passed along the washer part 810 of the product flow path 800 through the water in the water bath 210 to clean and reduce an amount of starch in the potato slices 110. Both the upper and lower endless washer belts 221, 222 and therefore the washer part 810 of the product flow path 800, pass below the water level 213 in the washer 20, to ensure that potato slices 110 are fully submerged in the water 212. The washer belt assembly 220 is configured to pass the potato slices 110 through the water bath 210 for 30 seconds. In particular, the upper and lower endless washer belts 221, 222 are driven at the same, constant speed so that potato slices 110 entrained therebetween take around 30 seconds to pass through the water bath 210.

The potato slices 110 are then removed from the water in the water bath 210 by the washer belt assembly 220 and passed to a sprayer 260 for spraying the potato slices 110 with water. The sprayer 260 further removes starch from the potato slices 110, such as starch which, by passing the potato slices 110 through the water bath 210, has been brought to a surface 211, 212 of each potato slice 110. The potato slices 110 are then passed between an upper washer air jet 271 and a lower washer air jet 272 configured to supply respective jets of air to respective upper and lower surfaces of the potato slices 110. In this way, the upper and lower air jets 271, 272 remove excess water from the respective upper and lower surfaces of the potato slices 110. The removed water is then captured in the water bath 210. The upper and lower endless washer belts 221, 222 grip and retain the potato slices 110 as they are passed through the jets of air from the upper and lower washer air jets 271, 272.

The upper and lower washer belts 221, 222 and the upper and lower washer air jets 271, 272 are similar in structure and arrangement to the upper and lower conditioner belts 321, 332 and the conditioner air jet 370 of the de-oiler 40, which is shown in FIG. 8 and described below in more detail. In particular, while not shown in the figures, the upper and lower washer jets 271, 272 each comprise an elongate nozzle extending across a width of the product flow path 800. This ensures that all potato slices 110 across the width of the product flow path 800 are exposed to jets of air.

The potato slices 100 are passed to, and released by the washer belt assembly 220 at, a washer release point 250 downstream of the upper and lower washer air jets 271, 272. The lower endless washer belt 222 then carries the potato slices 110 towards the conditioner 30, while the upper endless washer belt 221 returns to the washer entrainment point 250 upstream of the water bath 210. The potato slices 110 leave the washer 20 at a second end 202 of the washer 20, downstream from the first end 201 of the washer 20.

The conditioner 30 (or “lipophilic conditioner”), as shown in FIG. 7, comprises an oil bath 310 comprising a reservoir 311 filled with oil 312 to an oil level 313. The oil 312 is heated to a temperature of 90° C. This elevated temperature imparts desirable organoleptic properties into the potato slices, as mentioned above, while ensuring that the potato slices 110 are not fried in the oil bath 310. The conditioner 30 comprises a conditioner belt assembly 320, which comprises an upper endless conditioner belt 321 and a lower endless conditioner belt 322 defining a conditioner part 820 of the product flow path 800 therebetween. As with the washer part 810 of the product flow path 800, the upper and lower endless conditioner belts 321, 321 are arranged so that the conditioner part 820 of the product flow path 800 has a height 330, defined between a lower surface 321a of the upper endless conditioner belt 321 and an upper surface 322a of the lower endless conditioner belt 322, that is less than a thickness of the potato slices 110. Again, the thickness is an average thickness, but may alternatively be a maximum or minimum thickness of the potato slices 110 in the product flow path 800.

The potato slices 110 are received on the upper surface 322a of the lower endless conditioner belt 322 from the washer 20 at a first end 301 of the conditioner 30. The potato slices 110 are then entrained in the conditioner part 32 of the product flow path 800 and gripped between the upper and lower endless conditioner belts 321, 322 at a conditioner entrainment point 340 upstream of the oil bath 310. The potato slices 110 are then passed along the conditioner part 820 of the product flow path 800 through the oil 312 in the oil bath 310. Both the upper and lower endless conditioner belts 321, 322, and therefore the conditioner part 820 of the product flow path 800, pass below the oil level 313 in the conditioner 30, to ensure that potato slices 110 are fully submerged in the oil 312. The conditioner belt assembly 320 is configured to pass the potato slices 110 through the oil bath 310 for 90 seconds. In particular, the upper and lower endless conditioner belts 321, 322 are both driven at the same, constant speed so that potato slices 110 entrained therebetween take around 90 seconds to pass through the oil bath 310.

The conditioner belt assembly 320 is then configured to remove the potato slices 110 from the oil bath 310 and pass the potato slices 110 to a de-oiler 40 downstream of the oil bath 310. The de-oiler 40 is shown in FIG. 8 and comprises two conditioner air jets (together referred to using the reference numeral 370), although only one is shown in FIG. 8 for clarity. In a similar way to the upper and lower washer air jets 271, 272 described above, the conditioner air jets 370 are configured to provide respective jets of air 371 to the potato slices 110 entrained between the upper and lower endless conditioner belts 321, 322. In this way, the de-oiler 40 removes oil from a surface (e.g., an upper and/or lower surface 111, 112) of a potato slice 11 passing through the jet of air 371 from the conditioner air jet 370. The conditioner air jets 370 are located so that oil removed from the potato slices 110 returns into the oil bath 310 under the action of gravity.

The conditioner air jets 370 together form the sole apparatus in the manufacturing line 1 for actively de-oiling the potato slices 110 before dehydrating the potato slices. In other words, the manufacturing line 1 and the conditioner 30 are absent any other apparatus, such as a water sprayer or brush, for actively removing oil from the potato slices 110 before dehydrating the potato slices 110. The term “actively de-oiling” does not include oil dripping off the potato slices under the action of gravity, which will be understood to constitute “passive” de-oiling. The conditioner air jets 370 are located so as to apply at least one jet of air to the potato slices 110 no later than five seconds from last contact of the potato slices 110 with the oil 312 in the oil bath 310. This ensures that the jet of air is applied before the potato slices reduce in temperature by 5° C. from last contact of the potato slices 110 with the oil 312 in the oil bath 310. Oil on a surface 111, 112 of the potato slices 110 is less viscous, and so is more readily removed by the conditioner air jet 370, at higher temperatures.

The conditioner air jet 370 shown in FIG. 8 is located so as to provide a jet of air to upper surfaces 111 of potato slices 110 in the conditioner part 820 of the product flow path 800. Specifically, the conditioner air jet 370 is located above the upper endless conditioner belt 321 in the conditioner 30, and a nozzle 372 of the conditioner air jet 370 is orientated towards the upper endless conditioner belt 321. The further conditioner air jet not shown in FIG. 8 is located to provide a corresponding jet of air to the lower surfaces 112 of potato slices 110 in the conditioner part 820 of the product flow path 800. Specifically, the further conditioner air jet is located below the lower endless conditioner belt 322 in the conditioner 30 and comprises a corresponding nozzle that is orientated towards the lower endless conditioner belt 322. Also not shown in FIG. 8, as with the washer air jets 271, 272, the nozzle 372 of the conditioner air jet 370 is elongate and extends across a width of the product flow path. It will be appreciated that, in other examples, the de-oiler 40 may comprise any other suitable number of conditioner air jets and/or nozzles 372, providing that any active de-oiling process is performed by the air jet(s) alone.

The conditioner air jet 370 and the upper and lower washer air jets 271, 272 are configured to supply the respective jets of air from respective nozzles 372 at a variable velocity of between 50 and 130 m/s. In particular, the conditioner 30 comprises a motor (not shown) for operating a fan (not shown) that provides an airflow to each of the conditioner air jets 370. The washer 20 comprises a similar motor and fan for providing an airflow to each of the washer air jets 371, 372. In each case, the motor is operable at a variable speed of up to 80 Hz. In other examples, the motor(s) is (are) operable at speeds of up to 50 Hz, up to 60 Hz, up to 70 Hz, up to 80 Hz, or greater than 80 Hz. This may provide a variable flow rate from the fan, which in turn may provide a variable flow rate of air through each nozzle 372, and so a variable velocity of the jet of air from each nozzle 372.

Each of the belts of the washer and conditioner belt assemblies 220, 320, are of a wire mesh type, comprising a plurality of interlinked metal wires forming a mesh structure. This provides a robust yet flexible belt assembly for firmly retaining the potato slices 110 in the product flow path 800 whilst reducing a risk of damage to the potato slices 110. Moreover, the mesh structure permits a greater surface area of the potato slices to be exposed to the water in the water bath, the oil in the oil bath, and the jets of air from the washer and conditioner air jets 271, 272, 370. In particular, each of the belts in both the washer 20 and the conditioner 30 has a total “open” area (i.e., an area between the interlinked wires) of around 85% of the total area of the respective belt.

After de-oiling, the potato slices 110 are passed to, and released by the conditioner belt assembly 320 at, a conditioner release point 350 downstream of the de-oiler 40. The lower endless conditioner belt 322 then carries the de-oiled potato slices 110 towards the shaping belt 50, while the upper endless conditioner belt 321 returns to the conditioner entrainment point 340 upstream of the oil bath 310. The potato slices 110 leave the conditioner 30 at a second end 302 of the conditioner 30, downstream from the first end 301 of the conditioner 30.

It will be understood that the undulating surface of the polymeric band of the shaping belt 50 may take any suitable shape, which may vary depending on the shape desired to be imparted into the potato slice. A spacing of the potato slices on the shaping belt 50 is maintained; however, the spacing need not be a regular spacing such as that in the array shown in FIG. 4. Instead, the potato slices 110 may be irregularly spaced, such as in a staggered array, on the shaping belt. In other examples, there may be a small degree of overlap, but it is preferable for a spacing of the potato slices to be maintained.

The shaping belt 50 is configured to carry the potato slices from the conditioner 30 into the primary microwave 61. The potato slices 110 remain on the shaping belt in the primary microwave 61 of the dehydrator 60. As the potato slices are heated in the microwave, they at least partly conform to the undulating surface of the shaping belt 50. The primary microwave 61 reduces a moisture content of the potato slices to between 7% and 10%. The primary microwave 61 has an available power output of up to 300 kW, and is operated between 160 kW and 210 kW. The speed of the polymeric belt and the power output can be varied to provide a desired moisture content and/or throughput.

The potato slices 110 are then passed to a deep bed conveyor in the deep bed microwave (not shown), the deep bed conveyor comprising trays for receiving the potato slices 110. The potato slices are not spaced apart in the trays, instead being stacked in piles, or “beds”, of about two-to-three potato slices 110 high. However, it will be appreciated that the “bed” may be deeper, such as up to five or greater than five potato slices 110 high. The deep bed microwave microwaves the potato slices at a power output of between 16 and 20 kW. This provides a moisture content of the potato slices of between 4% and 6%.

An example dehydrating process—which includes conveying potato slices through a primary microwave on a conveyor having an undulating surface, and then passing the potato slices to a deep bed conveyor—is shown and described in the published international patent application number WO2012104219.

The potato slices 110 are then passed from the deep bed microwave to the oven 62 for final drying, or baking, to produce the potato crisps. A temperature set point of the oven 62 is 135° C., with a range of +/−5° C. The potato slices remain in the oven for over 7.5 minutes, with a range of +/−30 seconds. The moisture content of the resulting potato crisps is in the range of 1.4% and 1.8%. Finally, the potato crisps are conveyed to the packager 70 and are packaged into crisp packets, such as by combining and funnelling the potatoes into crisp packets, which are then sealed. In other examples, however, the potato crisps may be packaged into any other suitable container, such as a box, and/or may be transported or transferred to another facility or manufacturing line for packaging.

It will be appreciated that the dehydrating, and specifically, the microwaving in the primary microwave 61 and deep bed microwave, and the drying in the oven 62, may be done in any other suitable way. For instance, other power outputs, times, conveyor speeds, and/or temperature ranges may be used according to specific implementations of the invention.

The potato crisps produced in the manufacturing line 1 typically have an oil content of around 10% to 11%, with a range of +/−1%. This provides a crisp which has a reduced oil content relative to a purely fried crisp (typically below 50% of the amount of oil in a fried crisp), while retaining desirable organoleptic properties, such as taste and texture, of the potato crisp.

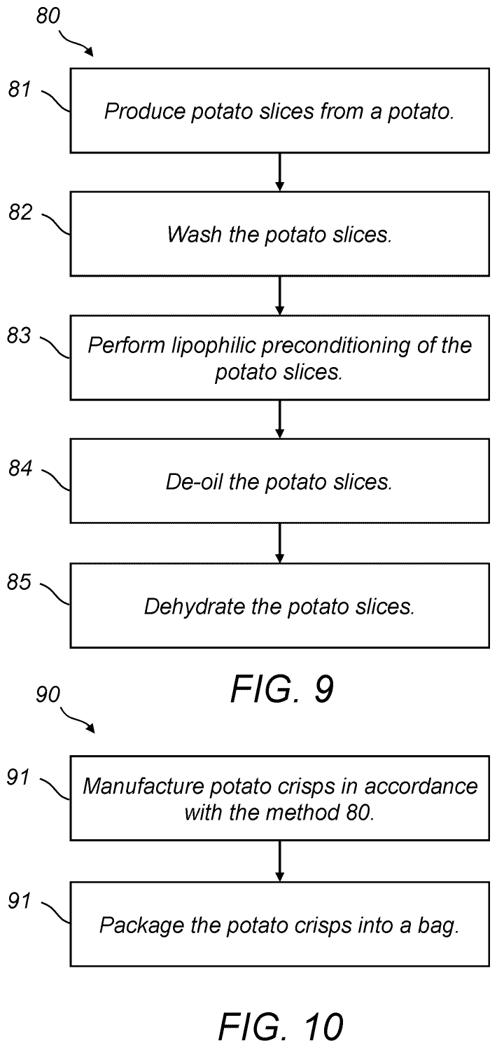

Turning now to FIG. 9, shown is an example method 80 of manufacturing a potato crisp. The method 80 corresponds to processes performed by the manufacturing line 1 described above. Specifically, the method 80 comprises: producing 81 an array of potato slices from a potato; washing 82 the potato slices 110 to produce washed potato slices 110, performing 83 lipophilic preconditioning of the washed potato slices 110 to produce conditioned potato slices 110; de-oiling 84 the conditioned potato slice 110 without wetting the potato slice to produce a de-oiled potato slice 110; and dehydrating 85 the potato slice to produce the potato crisp.

The producing 81 potato slices 110 from the potato 100 corresponds to the process performed by the slicer 10 described above. In particular, the producing 81 potato slices 110 comprises: receiving the potato 100 in the receptacle 120; retaining, using the retainer 170, the potato 100 in the receptacle 120 so that the potato protrudes from the outlet 142; and causing movement of the receptacle 120 in the reciprocating motion relative to the cutting tool 160, so that a part of the potato 100 protruding from the outlet 142 is caused to pass across the cutting edge 161 so that the potato 100 is sliced by the cutting edge to produce the potato slices 110. The method 80 also comprises causing the potato slice to be captured on the conveyor 190. It will be appreciated that, in various examples, the producing 81 the potato slices 110 may comprise any of the processes described above in relation to the slicer 10.

The washing 82 the potato slices corresponds to processes performed by the washer 20 described above, which includes conveying the potato slices 110 through the water bath 210 between the upper and lower endless washer belts 221, 222, spraying the potato slices 110 with water, and then applying jets of air to the potato slices 110. The performing 83 lipophilic preconditioning of the washed potato slices corresponds to processes performed by the conditioner 30 described above, which comprises conveying the potato slices 110 along the conditioner part 820 of the product flow path 800, which passes through the oil bath 310 comprising oil at a temperature of 85° C., between the upper and lower endless conditioner belts 321, 322. The de-oiling 84 the conditioned potato slices 110 comprises applying the jet of air from the conditioner air jet 370 to the potato slices 110, specifically while the potato slice is retained between the upper and lower endless conditioner belts 321, 322. Finally, the dehydrating 85 the potato slices corresponds to processes performed by the dehydrator 60, which includes microwaving the potato slices in the primary microwave 61 and/or the deep bed microwave, and drying the potato slices in the oven 62 to produce the potato crisps.

FIG. 10 shows an example method 90 of producing a bag of potato crisps. The method 90 comprises manufacturing 91 the potato crisps in accordance with the method 80 described above, and packaging 92 the potato crisps into a bag using the packager 70.

Example embodiments of the present invention have been discussed, with reference to the examples illustrated; however, it will be appreciated that variations and modifications may be made without departing from the scope of the invention as defined by the appended claims.

1. An apparatus for producing potato slices from potatoes, the apparatus comprising:
a spaced array of receptacles, each receptacle comprising a respective inlet for receiving a potato, and a respective outlet through which the potato can protrude;
a retainer for limiting an extent to which the potatoes protrude from the outlets of the receptacles; and
a cutting tool comprising a cutting edge for cutting the potatoes;
wherein the receptacles are each movable in a reciprocating motion relative to the cutting tool to cause a part of the potato protruding from the respective outlet to pass across the cutting edge so that the potato is sliced by the cutting edge to produce the potato slices; and
wherein the apparatus comprises a conveyor arranged to capture the potato slices.

2. The apparatus of claim 1, wherein each receptacle is orientated so that the potato is caused to protrude from the respective outlet due to the action of gravity, at least as the potato is caused to pass across the cutting tool.

3. The apparatus of claim 1 or claim 2, wherein each receptacle comprises a tube having a height and diameter so that potatoes received through the inlet are stackable in a single stack of potatoes in the tube.

4. The apparatus of claim 3, wherein each tube has a pattern on an internal surface thereof.

5. The apparatus of claim 4, wherein the pattern comprises equally circumferentially spaced protrusions which extend along a length of each tube.

6. The apparatus of any one of claims 1 to 5, wherein the retainer comprises an upper surface arranged to abut an end of a potato protruding from the outlet of each receptacle, and to guide each potato towards the cutting edge of the cutting tool during a cutting stroke of the reciprocating motion; and
wherein the apparatus comprises a gap between the upper surface and the cutting edge of the cutting tool, wherein a thickness of the potato slices produced by the apparatus depends on a size of the gap.

7. A method of producing potato slices from a potato, the method comprising:
receiving a potato in each receptacle of a spaced array of receptacles, each receptacle comprising an inlet and an outlet through which a respective potato can protrude;
retaining, using a retainer, a potato in each receptacle so that the potato protrudes from the respective outlet; and
causing movement of each receptacle in a reciprocating motion relative to a cutting tool, the cutting tool comprising a cutting edge for cutting the potato in each receptacle;
wherein the causing movement of the receptacle causes a part of the potato protruding from each outlet to pass across the cutting edge so that the potato is sliced by the cutting edge to produce the potato slices.

8. The method of claim 7, wherein the causing movement of the receptacles comprises causing movement of the receptacles in a pendulum motion.

9. The method of claim 7 or claim 8, wherein the retainer is adjustable to adjust a size of a gap between the retainer and the cutting tool, and the method comprises adjusting the retainer to adjust the size of the gap.

10. The method of any one of claims 7 to 9, wherein two or more of the receptacles in the array of receptacles are tubular and have different diameters, and wherein the receiving a potato in each receptacle comprises receiving respective potatoes of different diameters in the respective two or more receptacles.

11. A method of manufacturing potato crisps comprising:
producing potato slices in accordance with the method of claim 10; and
cooking the potato slices to produce the potato crisps.

12. A manufacturing line for manufacturing potato crisps, the manufacturing line comprising:
the apparatus of any one of claims 1 to 6 for producing potato slices;
a washer configured to wash the potato slices to produce washed potato slices;
a lipophilic conditioner configured to perform lipophilic conditioning of the washed potato slices to produce conditioned potato slices; and
a dehydrator configured to dehydrate the conditioned potato slices to produce the potato crisps.

13. An apparatus for washing and performing lipophilic preconditioning of a potato slice in the manufacture of a potato crisp, the apparatus comprising:
a water bath into which water is receivable for washing the potato slice, and an oil bath into which oil is receivable for performing lipophilic preconditioning of the potato slice; and
a belt assembly comprising an upper endless belt and a lower endless belt, the upper and lower endless belts defining a product flow path therebetween, the product flow path passing through the water bath and/or the oil bath;
wherein the product flow path has a height, defined between lower and upper surfaces of the respective upper and lower endless belts, which is equal to or less than a thickness of the potato slices.

14. The apparatus of claim 13, comprising at least one air jet configured to apply a respective at least one jet of air to the potato slice in the product flow path downstream of the water bath.

15. The apparatus of either claim 13 or claim 14, comprising at least one air jet configured to apply a respective at least one jet of air to the potato slice in the product flow path downstream of the oil bath.

16. The apparatus of any one of claims 13 to 15, wherein the upper and lower endless belts are oil-and water-permeable.

17. A method of washing and performing lipophilic preconditioning of a potato slice in the manufacture of a potato crisp, the method comprising:
washing the potato slice by conveying the potato slice through a water bath to produce a washed potato slice;
performing lipophilic preconditioning of the washed potato slice by conveying the potato slice through an oil bath comprising oil at a temperature of from 75° C. to 90° C., to produce a preconditioned potato slice; and
conveying the potato slice through the water bath and/or through the oil bath along a product flow path defined between an upper endless belt and a lower endless belt; and
wherein the product flow path has a height, defined between lower and upper surfaces of the respective upper and lower endless belts, which is equal to or less than a thickness of the potato slices.

18. A manufacturing line for manufacturing a potato crisp from a potato, the manufacturing line comprising:
a slicer for slicing the potato to produce a potato slice;
the apparatus of any one of claims 13 to 16 for washing and performing lipophilic conditioning of the potato slice to produce a washed and preconditioned potato slice; and
a dehydrator for dehydrating the washed and preconditioned potato slice to produce a dehydrated potato slice.

19. A method of manufacturing a potato crisp from a potato, the method comprising:
slicing the potato to produce a potato slice;
washing and performing lipophilic conditioning of the potato slice in accordance with the method of claim 17 to produce a washed and preconditioned potato slice;
dehydrating the preconditioned potato slice to produce the potato crisp.

20. A method of manufacturing a potato crisp from a potato slice, the method comprising:
performing lipophilic preconditioning of the potato slice by conveying the potato slice along a product flow path that passes through an oil bath comprising oil at a temperature of from 75° C. to 95° C., to produce a preconditioned potato slice;
conveying the preconditioned potato slice along the product flow path from the oil bath to at least one air jet;
de-oiling the preconditioned potato slice by applying at least one jet of air to the potato slice from a respective at least one air jet to produce a de-oiled potato slice; and
dehydrating the de-oiled potato slice to produce the potato crisp;
wherein the applying the at least one jet of air from the respective at least one air jet is the sole active de-oiling action performed between conveying the potato slice through the oil bath and dehydrating the de-oiled potato slice, and
wherein the potato crisp comprises an oil content of up to 18 wt. %, based on the total weight of the potato crisp.

21. The method of claim 20, comprising applying the at least one jet of air to the preconditioned potato slice no later than 12 seconds from last contact of the preconditioned potato slice with oil in the oil bath.

22. The method of claim 20 or claim 21, comprising applying the jet of air before the preconditioned potato slice reduces in temperature by 10° C. from last contact of the preconditioned potato slice with oil in the oil bath.

23. The method of any one of claims 20 to 22, wherein the product flow path is defined between an upper endless belt and a lower endless belt, and wherein the product flow path has a height, defined between lower and upper surfaces of the respective upper and lower endless belts, which is equal to or less than a maximum thickness of the potato slices.

24. A manufacturing line for manufacturing a potato crisp from a potato slice, the manufacturing line comprising:
a product flow path along which the potato slice is passable through the manufacturing line;
an oil bath through which the product flow path passes, the oil bath being for performing lipophilic preconditioning of the potato slice to produce a preconditioned potato slice;
at least one air jet configured to apply a jet of air to the preconditioned potato slice in the product flow path downstream of the oil bath to produce a de-oiled potato slice; and
a dehydrator for dehydrating the de-oiled potato slice to produce the potato crisp;
wherein the at least one air jet is the sole apparatus in the manufacturing line for actively de-oiling the preconditioned potato slice before dehydrating the preconditioned potato slice; and
wherein the manufacturing line is configured to produce a potato crisp comprising an oil content of up to 18 wt. %, based on the total weight of the potato crisp.

25. A method of producing a bag of potato crisps, comprising manufacturing potato crisps according to the method of any one of claims 11, 19, or 20 to 23, and packaging the potato crisps into a bag.

26. A potato crisp manufactured according to the method of any one of 11, 19 or 20 to 24, optionally wherein the crisp is packaged into a bag according to the method of claim 25.
